(19) United States
(12) Patent Application Publication
(10) Pub. No.: US 2013/0151041 A1
(43) Pub. Date: Jun. 13, 2013

(54) METHOD AND SYSTEM FOR OPERATING A LOCOMOTIVE

(71) Applicants: Tom OTSUBO, Oak Grove, MO (US); Jeffrey Keith Baker, Overland Park, KS (US); Jerome Stephen Beshoner, Pleasant Hill, MO (US); Craig Alan Stull, Kansas City, MO (US); William Edward Hagen, West Melbourne, FL (US); Shawn Thomas Clark, Melbourne, FL (US); Stephen Harold Humphrey, Pleasant Hill, MO (US); Brenton Ho Frakes, Oak Grove, MO (US)

(72) Inventors: Tom OTSUBO, Oak Grove, MO (US); Jeffrey Keith Baker, Overland Park, KS (US); Jerome Stephen Beshoner, Pleasant Hill, MO (US); Craig Alan Stull, Kansas City, MO (US); William Edward Hagen, West Melbourne, FL (US); Shawn Thomas Clark, Melbourne, FL (US); Stephen Harold Humphrey, Pleasant Hill, MO (US); Brenton Ho Frakes, Oak Grove, MO (US)

(21) Appl. No.: 13/495,151

(22) Filed: Jun. 13, 2012

Related U.S. Application Data
(63) Continuation-in-part of application No. 12/023,388, filed on Jan. 31, 2008, now abandoned.
(60) Provisional application No. 60/889,436, filed on Feb. 12, 2007.

(51) Int. Cl. B64D 31/00

(52) U.S. Cl. CPC B64D 31/00
USPC 701/20

(57) ABSTRACT

A method for operating a locomotive is provided. The method includes coupling a processor within the locomotive to monitor at least one of an operating parameter and an equipment operation. The method also includes determining a status of a locomotive pre-trip or departure test using the processor and operating an interlock based on the status of the pre-trip or departure test, wherein the interlock is configured to regulate an operating speed of the locomotive.

### CROSS REFERENCE TO RELATED APPLICATIONS

The present application is a continuation-in-part of U.S. patent application Ser. No. 12/023,388, filed Jan. 31, 2008 entitled “Method and System for Operating a Locomotive,” which claims the benefit of Provisional Application No. 60/889,436, filed on Feb. 12, 2007, the entire disclosures of which are incorporated by reference herein.

### BACKGROUND OF INVENTION

This invention relates generally to locomotives, and, more particularly, to a method and a system for operating a locomotive.

Locomotives are operated in a variety of geographic locations, by a variety of operators. To ensure that the locomotives, and the control systems used within those locomotives, are operating correctly and safely, and that such systems include the latest controller upgrades, at least one pre-trip or departure test is typically performed by the locomotive operator. The pre-trip or departure test validates and confirms that the locomotive has the correct operating parameters and that the equipment is operational.

At least some guidelines mandate that a pre-trip or departure test be performed on each locomotive within a pre-determined operational interval. For example, some guidelines mandate that a pre-trip or departure test be performed at least once every twenty-four hours. Generally, a locomotive operator is responsible for ensuring that the pre-trip or departure test has been performed within the operational interval. For example, the operator may enter the time and date of the last pre-trip or departure test into a logbook and then periodically consult the logbook to determine when the next pre-trip or departure test is required.

In the United States, Title 49 of the Code of Federal Regulations (CFR), Section 236.587 requires a departure test including testing the automatic train stop, train control or cab signal apparatus on each locomotive on departure of the locomotive from its initial terminal or at least once within a 24-hour period if the train makes more than one trip in such 24-hour period. Locomotives having mechanical trip stops are excluded from the departure test requirements.

In other countries or regions, the authorities governing rail transportation typically have similar requirements for pre-trip tests for periodically checking the operation of signaling and/or communications systems used by locomotives within a railway network.

Accordingly, as used herein the term pre-trip test generally refers to a test of the operational condition or status of certain communication, control, braking or signaling systems of a locomotive or other vehicle which are related to the safe operation of the locomotive or vehicle.

The term departure test as used herein refers to a test of the automatic train stop, train control, or cab signal apparatus on each locomotive, except a locomotive or a multiple-unit car equipped with mechanical trip stop, the test including using one of the following methods: (1) Operation over track elements; (2) Operation over test circuit; (3) Use of portable test equipment; or (4) Use of onboard test device as set forth in U.S. CFR §236.587. Thus, the term pre-trip test as used herein includes a departure test.

Often, the ultimate responsibility for performing the departure test or a pre-trip test within any required operational time interval lies with the locomotive operator. Known locomotives do not include a system that is capable of determining that a pre-trip or departure test has been performed or when the next pre-trip or departure test is scheduled to be performed. As a result, some locomotives may enter into service without performing a pre-trip or departure test or verifying that a pre-trip or departure test has been performed.

### BRIEF DESCRIPTION

In one aspect, a method for operating a locomotive is provided. The method includes using a processor within the locomotive to monitor at least one of an operating parameter and an equipment operation of the locomotive. The method also includes determining a status of a departure test of the locomotive using the processor and operating an interlock based on the status of the departure test, wherein the interlock is configured to regulate an operating speed of the locomotive.

In another aspect, a system for use in operating a locomotive is provided. The system includes at least one interlock configured to regulate an operating speed of a locomotive and a processor configured to determine a status of a pre-trip or departure test of the locomotive, the processor further configured to control an operation of the interlock based on the status of the pre-trip or departure test.

In another aspect, an interlock system for use with a vehicle is provided. The interlock system includes at least one interlock configured to regulate an operating speed of the vehicle and a processor configured to determine a status of a vehicle departure test, the processor further configured to control an operation of the interlock based on the status of the departure test.

In another aspect, the system includes a processor onboard a locomotive configured to transfer information regarding the status of a pre-trip or departure test to a remote location via a communication system.

### BRIEF DESCRIPTION OF DRAWINGS

FIG. 1 is a block diagram of an exemplary control system that may be utilized with a locomotive; and

FIG. 2 is an exemplary onboard display that may be generated utilizing the control system shown in FIG. 1.

### DETAILED DESCRIPTION

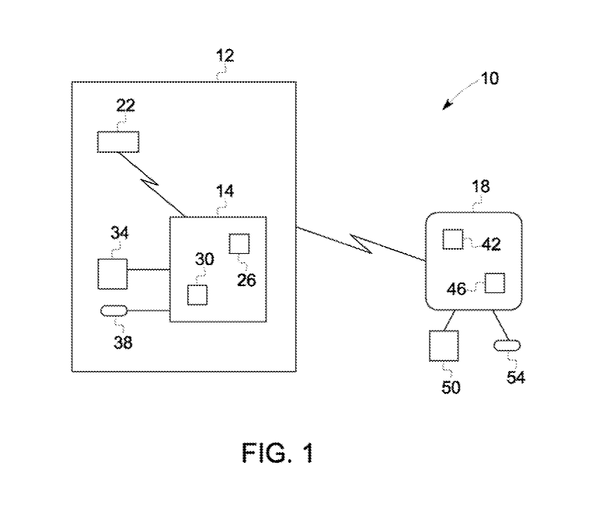

FIG. 1 is a block diagram of an exemplary system 10 for use in operating a locomotive. In the exemplary embodiment, system 10 includes an onboard computer (OBC) 14 disposed on a locomotive 12, a server 18 that may be located at a fixed remote site, and a tracking system 22 for use in tracking a position of a vehicle such as locomotive 12. OBC 14 includes a processor 26 that performs vital and non-vital calculations, as well as vital coding and decoding of information, and a data storage device 30, such as a hard disc, or memory for storing data including a database. Additionally, in the exemplary embodiment, OBC 14 is connected to an OBC display 34 for viewing information, data, and possible graphical representations and an OBC user interface 38 that allows a user to input information, data, and/or queries to OBC 14, using a keyboard or a mouse, for example. In the exemplary embodiment, server 18 includes a processor 42 that performs vital and/or non-vital calculations, as well as coding and decoding of information, and a data storage device 46 that, in one embodiment, includes a hard disc or memory device for storing a database. As used herein, the term “processor” is not limited to only integrated circuits referred to in the art as a processor, but broadly refers to a computer, a microcontroller, a microcomputer, a programmable logic controller, an application specific integrated circuit and any other programmable circuit. Furthermore, in the exemplary embodiment, server 18 is connected to a server display 50 for viewing information, data, and graphical representations and is connected to a server user interface 54 that allows a user to input information, data, and/or queries to server 18, using a keyboard or a mouse, for example.

In the exemplary embodiment, both OBC 14 and server 18 interface with various control elements (not shown), such as sensors, actuators, alarms, etc. on the locomotive 12 and wayside devices, such as guideway switches for selecting among two or more diverging routes, signals, and occupancy detection circuits associated with a track network (not shown). Additionally, in the exemplary embodiment, OBC 14 exchanges information with server 18 via a communications system, such as a mobile radio network. Tracking system 22 includes position sensors (not shown) and devices (not shown), such as a global positioning system (GPS) receiver, a tachometer, a gyroscope, an odometer, location tags along the guideway, and an onboard tag reader. In the exemplary embodiment, tracking system 22 is separate from OBC 14 and receives inputs from at least one GPS satellite (not shown). Alternatively, tracking system 22 may receive and utilize differential correction information to improve location determination accuracy and/or integrity.

In FIG. 1, an exemplary onboard tracking system 22 is separate (i.e., located remotely) from OBC 14. In another embodiment, OBC 14 includes tracking system 22. Alternatively, tracking system 22 has components that are separate from OBC 14 and components that are included in OBC 14. For example, in one embodiment, tracking system 22 components, such as a global positioning system receiver and/or software algorithms, may be included in OBC 14, while other tracking system 22 components, such as a tachometer, a gyroscope, an odometer, and/or a guideway tag reader, may be separate from OBC 14.

In an embodiment, server 18 is located at a mobile site, such as a mobile office structure or a locomotive. In an alternative embodiment, server 18 is located at a control facility or other facility at a remote location. In an embodiment, data storage device 30 is not included in OBC 14, but rather data storage device 30 is coupled to OBC 14. In another embodiment, data storage device 46 may not be included in server 18, but rather is coupled to server 18.

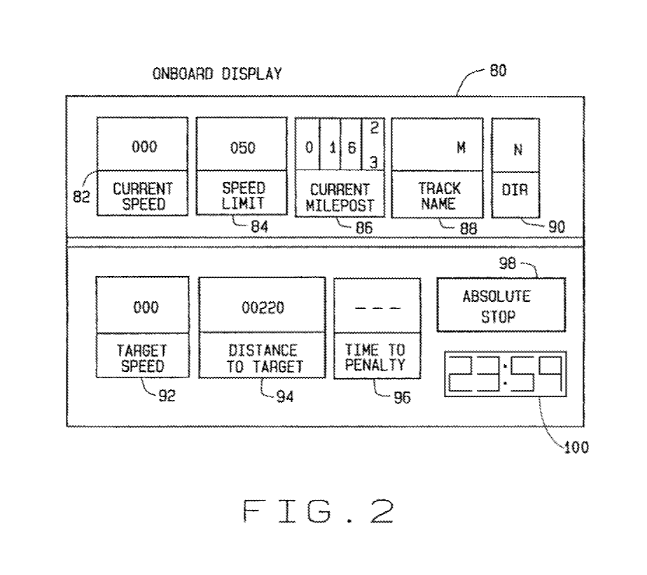

FIG. 2 is an exemplary embodiment of a graphical representation 80 that may be displayed on OBC display 34, such as information related to controlling or restricting the movement of a vehicle (e.g., locomotive 12). In the exemplary embodiment, graphical representation 80 includes a current speed indicator 82, a speed limit indicator 84, a current milepost indicator 86, a track name indicator 88, a direction indicator 90, a target speed indicator 92, a distance to target indicator 94, a time to penalty indicator 96, and an absolute stop indicator 98, each of which are used to convey vehicle movement controls or restrictions. Based on composite equivalent block status messages received by OBC 14, equipment on board each vehicle, such as OBC display 34, displays information or restrictions necessary to safely control the vehicle. As shown in graphical representation 80, in the exemplary embodiment, information necessary to safely control the vehicle includes information pertinent to that vehicle, a target description, limits on the range of movement allowed for the vehicle, and speed restrictions that may be stored on board. In another embodiment, the display displays signal aspects, such as red, yellow and green lights, rather than target-based movement constraints. In addition, in the exemplary embodiment, system 10 includes an audible alarm unit (not shown) that provides warnings of upcoming targets, limits, signal aspect changes to a more restrictive state, or braking action that has been taken.

As discussed above, at least some guidelines mandate that a pre-trip or departure test be performed on each locomotive within a pre-set time interval. As set forth above, a departure test requires written certification as to the completion of the departure test. Other pre-trip tests may include or require validation or confirmation that either a specific locomotive operating parameter is proper and/or that a piece of locomotive equipment is operational.

As set forth above, a departure test requires written certification that the departure test was properly performed. The written certification and the test results are posted in the cab of the locomotive 12 and a copy of the certification and test results are provided to remain at the location of the test for filing in the office of a supervisory official having jurisdiction over the location of the test. Further, at least one departure test is required in any 24-hour period for each locomotive.

While a departure test as described herein is directed to use with a locomotive, the scope of the present disclosure is not limited to locomotives and/or a departure test. Thus, one skilled in the art will recognize that embodiments of the system and method disclosed herein may be used with other types of vehicles or pre-trip tests other than a departure test.

As mentioned above, pre-trip tests are generally performed at pre-set time intervals. For example, departure tests should be performed at least every twenty-four hours. However, while twenty-four hours is an acceptable time interval between departure tests, it should be realized that this time limitation is exemplary only and that any pre-set time interval may be used in connection with the method and system described herein.

To assist an operator in determining how much time remains in a pre-set time interval for completing a successful departure test, in the exemplary embodiment, computer system 10 also includes a departure test indicator 100, such as a clock that is configured to display an amount of time remaining in the pre-set time interval (e.g., 24 hours). In an embodiment, departure test indicator 100 determines and displays the time remaining in the pre-set time interval until either the pre-set time interval expires and/or a departure test is successfully completed. In an embodiment, OBC 14 is configured to repeatedly reset departure test indicator 100 and restart the pre-set time interval upon the completion of each successful departure test, thereby beginning a new count down of the pre-set time interval until either the pre-set time interval expires and/or another departure test has been successfully completed. Optionally, the pre-set time interval may be configured at the factory or may be configured by an operator onboard the locomotive using computer system 10.

As used herein, an interlock is defined as a physical structure, such as, for example, a throttle regulating device, that is utilized to control the operating speed of a locomotive. In an embodiment, OBC 14 is configured to determine a status of a departure test and control the operation of an interlock based upon that status. For example, if OBC 14 determines that a departure test has not been successfully completed within the pre-set time interval, OBC 14 activates the interlock. Moreover, and for example, if OBC 14 determines that a completed departure test was unsuccessful, OBC 14 activates the interlock. In an embodiment, the interlock may be programmed into software and stored on OBC 14, for example.

In an embodiment, the system disclosed includes a locomotive having a processor configured to determine a status of a departure test for the locomotive, the processor being further configured to control an operation an interlock configured to regulate an operating speed of the locomotive based on the status of the departure test.

In an embodiment, the departure test is designated for testing: (a) the automatic train stop, train control, or cab signal apparatus on each locomotive, except a locomotive or a multiple-unit car equipped with mechanical trip stop, using one of the following methods:
(1) Operation over track elements;
(2) Operation over a test circuit;
(3) Use of portable test equipment; or
(4) Use of an onboard test device.
(b) The departure test shall be made on departure of the locomotive from its initial terminal unless that apparatus will be cut out between the initial terminal and an equipped territory. If the apparatus is cut out between the initial terminal and the equipped territory the test shall be made prior to entering the equipped territory.
(c) If a locomotive makes more than one trip in any 24-hour period, only one departure test is required in such 24-hour period.
(d)(1) Whoever performs the departure test shall certify in writing that such departure test was properly performed. The certification and the departure test results shall be posted in the cab of the locomotive and a copy of the certification and test results left at the test location for filing in the office of the supervisory official having jurisdiction.
(2) If it is impractical to leave a copy of the certification and departure test results at the location of the departure test, the departure test results shall be transmitted to either (i) a dispatcher or (ii) one other designated individual at each location, who shall keep a written record of the departure test results and the name of the person performing the departure test. These records shall be retained for at least 92 days.

In an embodiment, if a locomotive is in operation when a pre-set time interval for completing a successful departure test expires, an interlock is activated by OBC 14 to prevent the locomotive from exceeding a pre-determined operating speed until a successful departure test has been completed, thereby allowing the locomotive to reach a designated service area in order to conduct a departure test and/or, once operation of the locomotive has ceased, preventing the locomotive from reentering operation until a successful departure test has been completed. Optionally, if a locomotive is not in operation when a pre-set time interval for completing a successful departure test expires, an interlock is activated by OBC 14 to prevent the locomotive from entering operation until a successful departure test has been completed. Alternatively, if a locomotive is not in operation when a pre-set time interval for completing a successful departure test expires, an interlock is activated by OBC 14 to prohibit the locomotive from exceeding a pre-determined operating speed until a successful departure test has been completed, thereby allowing the locomotive to reach a designated service area in order to conduct a departure test and/or, once operation of the locomotive has ceased, preventing the locomotive from reentering operation until a successful departure test has been completed. In the exemplary embodiment, a pre-determined operating speed is set at the factory. In an alternative embodiment, a pre-determined operating speed may be set by an operator of the locomotive.

In an embodiment, the system disclosed includes a locomotive having a processor configured to determine a status of a pre-trip test for the locomotive, the processor being further configured to control an operation an interlock configured to regulate an operating speed of the locomotive based on the status of the pre-trip test.

As will be appreciated by one skilled in the art and based on the foregoing specification, the above-described embodiments of the invention may be implemented using computer programming or engineering techniques including computer software, firmware, hardware or any combination or subset thereof, wherein the technical effect is to ensure that a locomotive departure test has been performed within a pre-set time interval. Any resulting program, having computer-readable code means, may be embodied or provided within one or more computer-readable media, thereby making a computer program product, i.e., an article of manufacture, according to the discussed embodiments of the invention. The computer readable media may be, for example, but is not limited to, a fixed (hard) drive, diskette, optical disk, magnetic tape, semiconductor memory such as read-only memory (ROM), and/or any transmitting/receiving medium such as the Internet or other communication network or link. The article of manufacture containing the computer code may be made and/or used by executing the code directly from one medium, by copying the code from one medium to another medium, or by transmitting the code over a network.

The method and system described herein facilitate ensuring that a locomotive cannot proceed into operation if a pre-set time limit between departure tests has expired and facilitate ensuring that the locomotive safely remains in operation if the locomotive is currently in operation when the pre-set time limit expires. As such, the method and system described herein increase safety by facilitating the installation of the most recent locomotive operating parameters and facilitating periodic testing of the locomotive equipment. Described herein are a method and a system that may be implemented into an Incremental Locomotive Control System (ITCS), for example. However, while the method and system described herein may be implemented into an ITCS system, it should be realized that a separate system, such as an onboard device, for example, could be utilized to perform the method and system described herein.

Exemplary embodiments of methods and systems for operating a locomotive are described above in detail. The methods and systems for operating a locomotive are not limited to the specific embodiments described herein, but rather, components of the methods and systems may be utilized independently and separately from other components described herein. For example, the methods and systems described herein may have other industrial or consumer applications and are not limited to practice with only locomotives as described herein. Rather, the present invention can be implemented and utilized in connection with many other industries.

While the invention has been described in terms of various specific embodiments, those skilled in the art will recognize that the invention can be practiced with modification within the spirit and scope of the claims.

What is claimed is:

1. A method for operating a locomotive, said method comprising:
monitoring, using a processor, at least one of an operating parameter or an equipment operation of a locomotive;
determining a status of a departure test for the locomotive using the processor; and
operating an interlock based on the status of the departure test, wherein the interlock is configured to regulate an operating speed of the locomotive.

2. A method in accordance with Claim 1, further comprising determining, using the processor, an amount of time remaining before a subsequent departure test is to be performed.

3. A method in accordance with claim 2, wherein determining an amount of time remaining before a subsequent departure test is to be performed comprises displaying a graphical representation of the amount of time remaining before the subsequent departure test is to be performed.

4. A method in accordance with claim 3, wherein displaying a graphical representation of the amount of time remaining before the subsequent departure test is to be performed comprises displaying an amount of time remaining in a pre-set time interval until one of the pre-set time interval expires and the subsequent departure test is successfully completed.

5. A method in accordance with claim 4, wherein displaying a graphical representation of the amount of time remaining before the subsequent departure test is to be performed further comprises resetting the pre-set time interval upon completion of the successful departure test.

6. A method in accordance with claim 1, wherein operating an interlock based on the status of the departure test comprises prohibiting the locomotive from entering into operation based on the status of the departure test.

7. A method in accordance with claim 1, wherein operating an interlock based on the status of the departure lest comprises limiting an operating speed of the locomotive below a pre-determined speed based on the status of the departure test.

8. A system for use in operating a locomotive, said system comprising:
at least one interlock configured to regulate an operating speed of a locomotive; and
a processor configured to determine a status of a departure test for the locomotive, said processor further configured to control an operation of said interlock based on the status of the departure test.

9. A system in accordance with claim 8, wherein said processor is further configured to determine an amount of time remaining before a subsequent departure test is to be performed.

10. A system in accordance with claim 9, wherein said processor is coupled to a display, said processor further configured to display the amount of time remaining before the subsequent departure test is to be performed.

11. A system in accordance with claim 10, wherein said processor is further configured to:
determine an amount of time remaining in a pre-set time interval during which the subsequent departure test is to be performed; and
display the amount of time remaining in the pre-set time interval until one of the pre-set time interval expires and the subsequent departure test is successfully completed.

12. A system in accordance with claim 11, wherein said processor is further configured to reset the pre-set time interval upon completion of a successful departure test.

13. A system in accordance with claim 8, wherein said processor is further configured to control an operation of said interlock to prohibit the locomotive from entering operation until a successful completion of a departure test is performed.

14. A system in accordance with claim 8, wherein said processor is further configured to control said interlock to prohibit the locomotive from exceeding a pre-determined operating speed based on the status of the departure test.

15. An interlock system for use with a vehicle, said interlock system comprising:
at least one interlock configured to regulate an operating speed of the vehicle; and
a processor configured to determine a status of a vehicle departure test, said processor further configured to control an operation of said interlock based on the status of the departure test.

16. A system in accordance with claim 15, wherein said processor is further configured to determine an amount of time remaining before a subsequent departure test is to be performed.

17. A system in accordance with claim 16, wherein said processor is further configured to:
determine an amount of time remaining in a pre-set time interval during which the subsequent departure test is to be performed; and
display the amount of time remaining in the pre-set time interval until one of the pre-set time interval expires and the subsequent departure test is successfully completed.

18. A system in accordance with claim 17, wherein said processor is further configured to reset the pre-set time interval upon completion of a successful departure test.

19. A system in accordance with claim 15, wherein said processor is further configured to control an operation of said interlock to prohibit the vehicle from entering operation until a successful completion of a departure test is performed.

20. A system in accordance with claim 15, wherein said processor is further configured to control said interlock to prohibit the vehicle from exceeding a pre-determined operating speed based on the status of the departure test.

21. A system for use in operating a rail vehicle, said system comprising:
at least one interlock configured to regulate an operating speed of a rail vehicle; and
a processor configured to determine a status of a pre-trip test for the rail vehicle, said processor further configured to control an operation of said interlock based on the status of the pre-trip test.
